(19) United States
(12) Patent Application Publication
(10) Pub. No.: US 2009/0132515 A1
(43) Pub. Date: May 21, 2009

(54) Method and Apparatus for Performing Multi-Phase Ranking of Web Search Results by Re-Ranking Results Using Feature and Label Calibration

(76) Inventors: Yumao Lu, San Jose, CA (US); Fuchun Peng, Sunnyvale, CA (US); Xin Li, Sunnyvale, CA (US); Nawaaz Ahmed, San Francisco, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 11/942,410

(22) Filed: Nov. 19, 2007

(51) Int. Cl. G06F 17/30

(52) U.S. Cl. 707/5; 707/E17.008

(57) ABSTRACT

A method and apparatus for performing multi-phase ranking of web search results by re-ranking results using feature and label calibration are provided. According to one embodiment of the invention, a ranking function is trained by using machine learning techniques on a set of training samples to produce ranking scores. The ranking function is used to rank the set of training samples according to its ranking score, in order of its relevance to a particular query. Next, a re-ranking function is trained by the same training samples to re-rank the documents from the first ranking. The features and labels of the training samples are calibrated and normalized before they are reused to train the re-ranking function. By this method, training data and training features used in past trainings are leveraged to perform additional training of new functions, without requiring the use of additional training data or features.

### FIELD OF THE INVENTION

The present invention relates to information retrieval applications, and in particular, to ranking retrieval results from web search queries.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

One of the most important goals of information retrieval, and in particular, the retrieval of web documents through a query submitted by a user to a search engine, is to produce a correctly-ranked list of relevant documents to the user. Because studies show that users follow the top-listed link in over one-third of all web searches, user satisfaction is highest when the results that appear at the top of the list are the indeed the results that are most relevant to the user's query.

Typically, a search engine employs a ranking function to rank documents that are retrieved when a query is executed. In one approach, the ranking function is generated through using one of a variety of machine learning algorithms, and in particular, through performing nonlinear regression on a set of training samples. In another embodiment, the machine learning algorithm includes building a stochastic gradient boosting tree. The goal of the ranking function is to predict a correct ranking score for a particular document in relation to a particular query. The documents are then ranked in the order of each document's ranking score.

Ranking scores for the training set are assigned by human editors who assign a label to each document. A label reflects a measure of the relevance of the document to the query. For example, the labels applied by the team of editors are Perfect, Excellent, Good, Fair, and Poor. Each label is translated into a real number score that represents the label. For example, the above labels correspond to scores of 10.0, 7.0, 3.5, 0.5, and 0, respectively.

In one approach, the training data comprise: a set of queries that are sampled from a log of query submissions; a set of documents that are retrieved based on each of the sampled queries; and a label assigned by the team of editors for each of the documents in the set of documents.

In one approach, each document is represented by a vector of the document's attributes, or features, in relation to the query that was executed to retrieve the particular document. Such a vector is known as a feature vector for the query-document pair. The feature vector can comprise values that represent hundreds of features. Features represented in the feature vector include statistical data, such as the quantity of anchor text lines in the document corpus that contain all the words in the query and point to the document, or the number of previous times the document was selected for viewing when retrieved by the query; and features regarding the query itself, such as the length of the query or the popularity of the query.

Once trained, the ranking function is used to predict a score or label for any particular query-document pair. In one approach, based solely on the feature vector of a query-document pair, a ranking function produces a score, which is used to rank the particular document among the set of documents retrieved by the query.

However, this approach of training a single function with a set of undifferentiated queries is not optimal due to certain inherent differences between queries. The query differences include, for example, the queries' different lengths, the queries' different relative obscurity or popularity of their subject matter, and the variety of users' intentions for submitting a particular query. A shorter query allows for a broader range of search results that are judged as Excellent. For example, the query “C++ programming” has hundreds of documents that can be labeled Excellent. In contrast, even the best result retrieved for a longer query may only be labeled as Fair. For example, an obscure query such as “$10 store in Miami airport” may retrieve only a few documents, the best of which is merely judged as Fair. Such unavoidable query differences among the wide range of possible queries produces inconsistent training data. Thus, training a ranking function on such training data does not fully exert the discriminative power of the training set.

One solution is to increase the size of the training data set until the query differences can be accounted for. For example, to obtain a sufficient quantity of training samples involving long queries, the size of the training data set needs to be increased from 1,000, for example, to 50,000. However, such an increase in size of the training data set is expensive, if not infeasible.

A second solution is to train a different model, i.e., to train a separate ranking function, for each of the different possible classes of queries. However, there are difficulties to this solution due to the difficulty involved with classifying queries into classes. Furthermore, like the above example, the increase in the size of the training data set required for targeted sampling in each of the query classes is expensive and undesirable.

Therefore, it would be desirable to overcome the defects of single-phase ranking, while avoiding the problems encountered by above-presented solutions.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates a computer system upon which an embodiment of the invention may be implemented.

### DETAILED DESCRIPTION

Techniques for increasing the accuracy of ranking documents that are retrieved by a web search query are described. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### First Phase of Ranking

An initial ranking function is trained on a machine learning algorithm. According to one embodiment of the invention, techniques for supervised learning are used to induce a ranking function from a set of training samples. One of the techniques is performing nonlinear regression on the set of training samples to generate the ranking function. Nonlinear regression techniques are useful for generating a continuous range of labels/ranking scores from the function. Alternatively, one embodiment of this invention can be applied to train functions for navigational queries, wherein the query is submitted with the intention of retrieving one specific web page. This class of queries requires that the machine learning algorithm produces a classifying function, wherein a retrieved document is either the expected result or not.

According to one embodiment, to gather training samples, queries are sampled uniformly from a query log of real searches submitted by users. The queries are submitted to commercial search engines to retrieve a set of documents for each query. The top results from retrievals for each query are gathered as the training documents. In one embodiment of the invention, the training documents are retrieved using a good retrieval function.

For each of the training documents, a representation of a particular document in relation to the query that was executed to retrieve the document (hereinafter, a “query-document pair”) is determined. According to one embodiment of the invention, the representation comprises certain attributes of the document relative to the query. For example, the representation is a feature vector for the query-document pair, wherein each attribute is represented as a real-number value in the feature vector. Features represented in the feature vector include statistical data, such as the quantity of anchor text lines in the document corpus that contain all the words in the query and point to the document, and the number of previous times the document was selected for viewing when retrieved by the query. According to one embodiment, each of the documents is also reviewed by a human editor, and a label that represents a measure of the relevance of the particular document to the query is assigned by the editor to each query-document pair.

Once an initial ranking function has been produced from one of the machine learning techniques, the initial ranking function is used to rank a set of samples based on the representation and the label. According to one embodiment, the set of samples comprises training samples. According to another embodiment, the set of samples is a different set than the training samples.

### Multi-Phase Ranking

One embodiment of the invention involves a method of training a second ranking function, which is a re-ranking function, without requiring additional training data, and without requiring additional features for each document representation. This is achieved by re-using the training samples that were used to train the initial ranking function. The initial ranking function produces a ranked set of documents for each query of the sampled queries. According to one embodiment of the invention, for each query, the top-ranked result produced by the initial ranking function is identified. The feature vector and the label for the top-ranked result are identified.

For each query, the feature vectors and the labels for each of the results are calibrated against the feature vector and the label for the top-ranked result. According to one embodiment, the feature vectors and the labels are calibrated against a particular result that is chosen to be a par result, and not necessarily the top-ranked result from the previous ranking. According to one embodiment, the feature vectors and the labels comprise real-number values. According to one embodiment, calibrating the results against the top-ranked result comprises subtracting the values associated with the top-ranked result from the values associated with each of the results. When calibration is performed by subtraction, the values for the top-ranked result are calibrated to zero, and the top-ranked result becomes the origin for the query and all the documents retrieved by the query. In another embodiment, calibrating comprises normalizing all the labels of all the documents for a particular query such that the scores are scaled between 0 and 1. For example, for all the documents retrieved by a particular query, each of the labels for the documents is divided by the label with the highest relevance score to generate the new label.

A new re-ranking function is trained on a supervised learning algorithm using the same set of training samples, except with calibrated feature vectors and calibrated labels. As with the first training, one re-ranking function is trained for all queries.

According to one embodiment of the invention, when a search engine receives a user query at run-time, the initial ranking function uses the feature vectors of the documents to produce ranking scores that are used to initially rank the documents. Then, each of the feature vectors of each of the results is calibrated against the feature vector for the top ranked result. Finally, the re-ranking functions use the calibrated feature vectors to generate new ranking scores for each of the documents to re-rank the documents. This procedure is repeated at run-time for as many re-ranking cycles as are necessary to achieve optimal results.

The training process can be repeated with subsequent calibrations and further re-ranking until a desired degree of accuracy is reached. A search relevance metric, for example, the discounted cumulated grade for the top N results (DCG(N)), is used to determine whether another round of re-ranking is beneficial for producing materially improved results.

The process of calibrating all the query results against a top-ranked result for the query reduces the effect of certain training inconsistencies caused by query differences. For example, as described in the background section, a long query is likely to produce only results with low relevancy labels, while a short query is likely to produce many results with high relevancy labels. The best document retrieved for a long query may only have a relevancy score of 3, while many documents retrieved for a short query may have the maximum relevancy score of 10. The calibration procedure performed by one embodiment of the invention resolves this query difference by calibrating the relevancy score for all top-ranked documents to zero. The results are normalized within the set of documents retrieved for a particular query, thus incorporating query difference and previous ranking experience to generate the final rankings.

### Hardware Overview

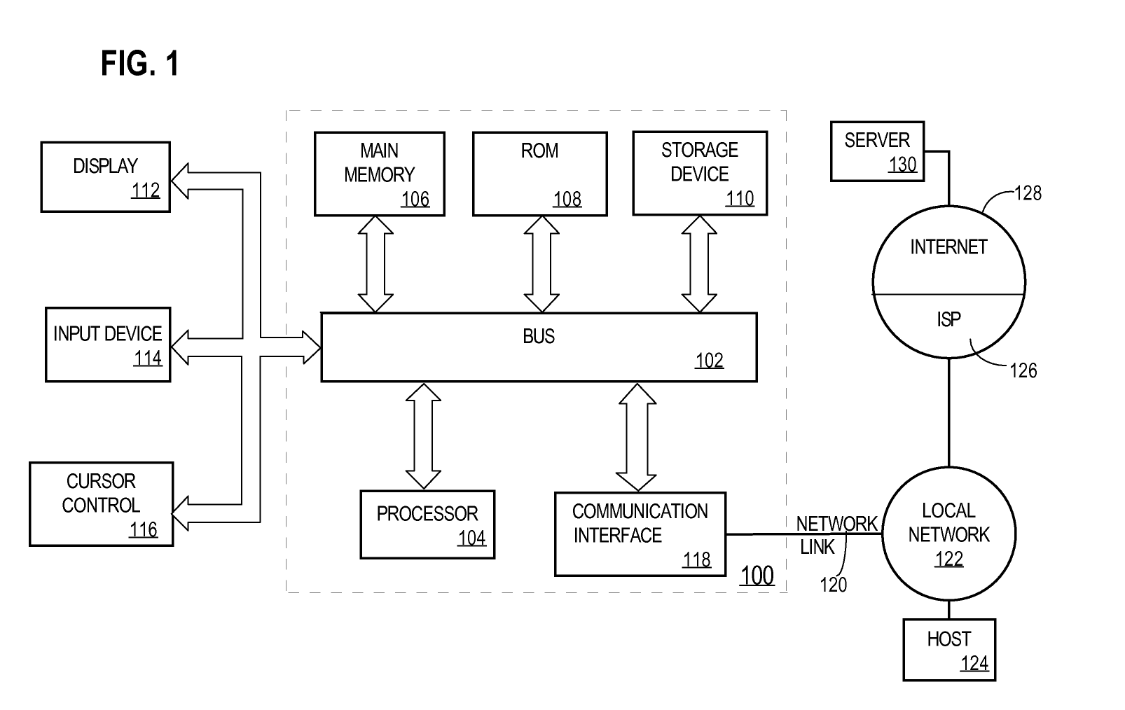

FIG. 1 is a block diagram that illustrates a computer system 100 upon which an embodiment of the invention may be implemented. Computer system 100 includes a bus 102 or other communication mechanism for communicating information, and a processor 104 coupled with bus 102 for processing information. Computer system 100 also includes a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT), for displaying information to a computer user. An input device 114, including alphanumeric and other keys, is coupled to bus 102 for communicating information and command selections to processor 104. Another type of user input device is cursor control 116, such as a mouse, a trackball, or cursor direction keys for communicating direction information and command selections to processor 104 and for controlling cursor movement on display 112. This input device typically has two degrees of freedom in two axes, a first axis (e.g., x) and a second axis (e.g., y), that allows the device to specify positions in a plane.

The invention is related to the use of computer system 100 for implementing the techniques described herein. According to one embodiment of the invention, those techniques are performed by computer system 100 in response to processor 104 executing one or more sequences of one or more instructions contained in main memory 106. Such instructions may be read into main memory 106 from another machine-readable medium, such as storage device 110. Execution of the sequences of instructions contained in main memory 106 causes processor 104 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 100, various machine-readable media are involved, for example, in providing instructions to processor 104 for execution. Such a medium may take many forms, including but not limited to storage media and transmission media. Storage media includes both non-volatile media and volatile media. Non-volatile media includes, for example, optical or magnetic disks, such as storage device 110. Volatile media includes dynamic memory, such as main memory 106. Transmission media includes coaxial cables, copper wire and fiber optics, including the wires that comprise bus 102. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 104 for execution. For example, the instructions may initially be carried on a magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector can receive the data carried in the infra-red signal and appropriate circuitry can place the data on bus 102. Bus 102 carries the data to main memory 106, from which processor 104 retrieves and executes the instructions. The instructions received by main memory 106 may optionally be stored on storage device 110 either before or after execution by processor 104.

Computer system 100 also includes a communication interface 118 coupled to bus 102. Communication interface 118 provides a two-way data communication coupling to a network link 120 that is connected to a local network 122. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals that carry digital data streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the world wide packet data communication network now commonly referred to as the “Internet” 128. Local network 122 and Internet 128 both use electrical, electromagnetic or optical signals that carry digital data streams. The signals through the various networks and the signals on network link 120 and through communication interface 118, which carry the digital data to and from computer system 100, are exemplary forms of carrier waves transporting the information.

Computer system 100 can send messages and receive data, including program code, through the network(s), network link 120 and communication interface 118. In the Internet example, a server 130 might transmit a requested code for an application program through Internet 128, ISP 126, local network 122 and communication interface 118.

The received code may be executed by processor 104 as it is received, and/or stored in storage device 110, or other non-volatile storage for later execution. In this manner, computer system 100 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method for ranking a set of documents retrieved by executing a query, the method comprising the steps of:
determining a par document from a set of one or more documents that are ranked in relation to a query;
calibrating a first label of a particular document from the set of one or more documents with a label of the par document to generate a second label for the particular document;
calibrating a first representation of the particular document with a representation of the par document to generate a second representation for the particular document;
generating a re-ranking function based on at least the second label and the second representation; and
re-ranking the set of one or more documents based on the re-ranking function.

2. The computer-implemented method as recited in claim 1, wherein the generating step comprises executing a machine-learning algorithm.

3. The computer-implemented method as recited in claim 2, wherein executing the machine learning algorithm includes performing nonlinear regression on training data.

4. The computer-implemented method as recited in claim 2, wherein executing the machine learning algorithm includes building a stochastic gradient boosting tree.

5. The computer-implemented method as recited in claim 1, wherein the step of calibrating the first label and the label of the par document further comprises subtracting the label of the par document from the first label.

6. The computer-implemented method as recited in claim 1, wherein the step of calibrating the first representation and the representation of the par document further comprises subtracting the representation of the par document from the first representation.

7. The computer-implemented method as recited in claim 1, wherein the par document is a top-ranked document from the set of one or more documents.

8. The computer-implemented method as recited in claim 1, wherein the labels comprise real-number values which represent a measure of relevance between a particular document and the query executed to retrieve the document.

9. The computer-implemented method as recited in claim 1, wherein the representations comprise real-number values which represent attributes of the documents in relation to the query.

10. The computer-implemented method as recited in claim 1, wherein a representation of a document comprises a feature vector of the document relative to the query executed to retrieve the document.

11. The computer-implemented method as recited in claim 1, further comprising repeating each of the steps as recited in the method of claim 1 to further re-rank the set of one or more re-ranked documents.

12. The computer-implemented method as recited in claim 1, wherein the query is expressed in natural language, and wherein the query comprises one or more words.

13. The computer-implemented method as recited in claim 1, wherein the documents in the set of one or more documents include web pages.

14. A computer-readable storage medium carrying one or more sequences of instructions for ranking a set of documents retrieved by executing a query, which instructions, when executed by one or more processors, cause the one or more processors to carry out the steps of:
determining a par document from a set of one or more documents that are ranked in relation to a query;
calibrating a first label of a particular document from the set of one or more documents with a label of the par document to generate a second label for the particular document;
calibrating a first representation of the particular document with a representation of the par document to generate a second representation for the particular document;
generating a re-ranking function based on at least the second label and the second representation; and
re-ranking the set of one or more documents based on the re-ranking function.

15. The computer-readable storage medium as recited in claim 14, wherein the generating step comprises executing a machine-learning algorithm.

16. The computer-readable storage medium as recited in claim 15, wherein executing the machine learning algorithm includes performing nonlinear regression on training data.

17. The computer-readable storage medium as recited in claim 15, wherein executing the machine learning algorithm includes building a stochastic gradient boosting tree.

18. The computer-readable storage medium as recited in claim 14, wherein the step of calibrating the first label and the label of the par document further comprises subtracting the label of the par document from the first label.

19. The computer-readable storage medium as recited in claim 14, wherein the step of calibrating the first representation and the representation of the par document further comprises subtracting the representation of the par document from the first representation.

20. The computer-readable storage medium as recited in claim 14, wherein the par document is a top-ranked document from the set of one or more documents.

21. The computer-readable storage medium as recited in claim 14, wherein the labels comprise real-number values which represent a measure of relevance between a particular document and the query executed to retrieve the document.

22. The computer-readable storage medium as recited in claim 14, wherein the representations comprise real-number values which represent attributes of the documents in relation to the query.

23. The computer-readable storage medium as recited in claim 14, wherein a representation of a document comprises a feature vector of the document relative to the query executed to retrieve the document.

24. The computer-readable storage medium as recited in claim 14, carrying instructions, which when executed, causes repeating each of the steps as recited in the method of claim 14 to further re-rank the set of one or more re-ranked documents.

25. The computer-readable storage medium as recited in claim 14, wherein the query is expressed in natural language, and wherein the query comprises one or more words.

26. The computer-readable storage medium as recited in claim 14, wherein the documents in the set of one or more documents include web pages.
